(19) United States
(12) Patent Application Publication
(10) Pub. No.: US 2006/0141247 A1
(43) Pub. Date: Jun. 29, 2006

(54) Adhesive tape, especially for masking of window flanges

(75) Inventors: Nicolai Bohm, Hamburg (DE); Siegfried Krupke, Tornesch (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 11/176,131

(22) Filed: Jul. 7, 2005

(30) Foreign Application Priority Data
Dec. 23, 2004 (DE) 10 2004 063 330.4

(51) Int. Cl. B32B 7/12; B32B 15/04

(52) U.S. Cl. 428/343; 428/354; 428/355 R; 428/355 AC

(57) ABSTRACT

A self-adhesive tape intended in particular for masking window flanges of automobiles, comprising a backing composed of two films disposed one above the other, the first film being composed of plasticized polyvinyl chloride (soft or sPVC) and the second of polyethylene terephthalate (PET) and the two films being joined with a laminating adhesive comprising a crosslinked, tackifier-resin-free acrylic ester polymer, characterized by a microshear travel of less than 60 μm (for a coat weight of 25 g/m²) and a delamination force of more than 3 N/cm, and also comprising a self-adhesive mass applied to the backing.

The invention relates to an adhesive tape, especially for masking of window flanges, in particular in automobile body shells coated with cathodic electrocoat material (CED). The purpose of the adhesive tape is to protect the window flanges against overpainting during the subsequent painting and baking operations, such that, following the removal of the adhesive tape, an automobile glass window can be installed on the surfacer- and clearcoat-free window flange using a reactive PU window adhesive.

Automobile glass windows are conventionally mounted in the painted vehicle body using rubber seals. In recent years, this technique has been increasingly replaced by the installation of the windows using reactive adhesives (based, for example, on polyurethane). The window is coated with the adhesive and placed on the body in such a way that the adhesive bead is pressed onto the window flange.

The installed windows, especially the windshields, nowadays act as a reinforcing element of the body. In the extreme case, that of the vehicle turning over, they prevent the roof columns from buckling. Consequently, a sufficient bond strength is critical to the safety of a modern motor vehicle in an accident situation.

Modern automotive finishes are composed of various coats, which are applied to the primed bodywork metal in the following order (schematically):
electrophoretic coat, usually cathodic electrocoat (CED)
surfacer or functional coat
color topcoat
clearcoat

Electrophoretic coating (electrodeposition coating or electrocoating) is a technique in which coating takes place by the action of an electrical field (50 to 400 V). The article to be painted, which conducts electric current, is introduced, as the anode or cathode, into the paint bath, with the tank wall acting in practice as the second electrode.

The amount of paint deposited is directly proportional to the amount of current supplied. Electrophoretic coating is used particularly for priming, in the automobile industry, for example. There are no spray losses, and the coatings obtained are highly uniform, even in difficult-to-reach areas. Where the substrates are not conducting, as in the case of plastics, glass, ceramic, etc., coating is carried out by way of the electrostatic charging of the paint particles (known as electrostatic coating).

If the automobile window is adhesively bonded, after the painting operation is complete, to the window flange, and the window flange as well has been painted, the following disadvantages arise.

Since the window adhesive has to be matched to the clearcoat as its adhesion substrate, an unnecessarily high degree of complexity may result, given the multiplicity of clearcoat materials used by the manufacturer, since it is necessary to hold in stock a multiplicity of appropriate adhesives. More important, however, is the fact that the overall bond strength of the automobile window depends on the weakest point in the multicoat paint system, and may therefore be much lower than the bond strength of the adhesive to the clearcoat.

It is therefore advantageous to apply the window to the bottommost paint coat, the CED coat. The number of CED products used by a manufacturer is normally lower than the number of clearcoat materials. Firstly, there are few defined adhesion substrates for the window adhesive, as a result, and, secondly, the system comprising primed metal/cathodic electrocoat/window adhesive, with two boundary layers, harbors a lower risk of fracture than a complex overall coating system.

To mask the window flange following the application of the cathodic electrocoat it is possible to use a PVC plastisol, as described in EP 0 655 989 B1. This plastisol is applied in liquid form to the window flange, painted over, and gelled during the baking phase at temperatures of at least 163° C., to form a solid film. A disadvantage of this technique is that, for the purpose of demasking after baking has taken place, it is necessary for a “grip tab” to be mechanically exposed, in which case the electrocoat may easily be damaged, harboring the risk of subsequent corrosion.

On the window flanges the plastisol strip crosses, in some cases more than once, PVC seam sealants which fill weld seams. On gelling, a frequent observation is of instances of severe sticking between seam sealants and PVC plastisol window flange masking, which make trouble-free demasking more difficult. Another observation is of plastisol-related contamination of the adhesion substrate, so giving rise to an adhesion failure at the boundary between window adhesive and formerly plastisol-masked cathodic electrocoat. As a result, the requisite bonding reliability of the window is not ensured.

Although this drawback can be countered through the use of a primer, such a step is labor-intensive, leads to unwanted solvent emissions, and may necessitate repair to the paint, as a result of accidental splashing or dripping on the clearcoat.

A more advantageous possibility for the masking of window flanges is the use of self-adhesive tapes. Their advantage over the plastisol is the much lower layer thickness of 100 to 200 μm, producing a correspondingly lower weight of waste per vehicle masked. The simultaneous disadvantage, however, is the risk of tearing the comparatively thin self-adhesive tape backing during demasking following application. This comes about on the one hand as a result of the fact that, during demasking, the self-adhesive tape is required to cut through a number of paint films and in doing so, starting from the edge, is always damaged by microscopically small jagged edges of the brittle clearcoat, from which tearing of the backing may develop. On the other hand, on the reverse face of the self-adhesive tape, there is a brittle, multilayer paint system with a thickness of approximately 100 μm, which removes any elasticity from the backing and therefore leads very easily to the backing tearing in the event of force peaks.

Because of the boundary condition whereby a self-adhesive tape for this application must also be able to be processed in automated form, by robot, in which case the backing is subjected to greater tensile loads than in the case of processing by hand, a two-coat construction has become established for the backing of a self-adhesive tape for masking window flanges.

Thus for many years a specialty adhesive tape has been available for this application, its backing being composed of a two-layer assembly of a plasticized polyvinyl chloride (soft or sPVC) film and a polyethylene terephthalate (PET) film. In this case the assembly of the two films is produced by means of a natural rubber self-adhesive mass.

The PET film in this assembly ensures high tensile strength; the sPVC side, which faces the paint, provides the assembly with the necessary toughness and resistance to the microjagged tearing edge of the paint.

A laminate in principle is a suitable solution for the utility of window flange masking. The principal disadvantage of the embodiment described above, however, lies in the use of the natural rubber self-adhesive mass as laminating adhesive. In the course of demasking, the laminate comprising this adhesive tends toward complete or at least partial splitting, generally accompanied by subsequent tearing, apparently as a consequence of the thermal load to which the self-adhesive tape is exposed during the drying of the paint films. Partial splitting in particular constitutes a safety risk, since the difference in color between the PET film, which remains on the window flange, and the cathodic electrocoat is minimal and the PET film can therefore be easily overlooked. These PET residues are a completely unsuitable adhesion medium for window adhesives and prevent reliable bonding of the window to the areas affected.

An improvement in this deficiency is proposed in DE 199 52 211 A1. Instead of a laminating adhesive comprising a natural rubber self-adhesive mass, a laminating adhesive based on acrylic ester polymer is disclosed. As set out in example 1 of this specification, this is the case in particular for polymers which have been blended with tackifier resins. The test condition for a demonstration of resistance is the subjection of the self-adhesive tape to a thermal load of 40 minutes at 170° C. followed by 30 minutes at 130° C. Under this load the proposed product construction actually functions well.

In practice, however, it emerges that a product construction of this kind does not provide the expected improvement. Instances of delamination occur as a consequence of a cohesive weakness in the laminating adhesive.

The main reason is that the operating conditions with regard to paint drying vary not only from one vehicle manufacturer to another but also, in some cases, from one plant to another. For example, the adhesive tape is conducted sometimes before and sometimes after the seam sealant is baked; in the former case, therefore, it is exposed to a further temperature cycle in addition to surfacer bake and clearcoat bake. In plants where the abnormalities occur the baking conditions prevailing are always harsher than those in which they occur to a lesser extent or not at all. In particular it should be borne in mind that drying ovens are run within operating windows: that is, in light of residence time and temperature, upper and lower limits are defined to which the body may be exposed.

The failure rate for body shells dried at the upper margin of the operating window is well above that for those dried at the lower margin. An unusually harsh upper operating limit, but one which does occur in practice, and which the tape must withstand without damage, is, for example, a thermal load of 50 minutes at 170° C. followed by 50 minutes at 165° C., followed in turn by 80 minutes at 145° C. It is obvious that these conditions are considerably harsher than those tested in DE 199 52 211 A1, which therefore do not cover more demanding cases in practice.

The weakness of cohesion of the laminate according to example 1 from DE 199 52 211 A1 is presumably the result of a thermally occasioned reduction in molecular weight of the acrylic ester polymer, which may have been additionally promoted by resin, which as a low molecular weight substance always weakens the cohesion.

Even acrylic ester polymers which are free from tackifier resins do not generally exhibit good suitability under the harsher thermal loads such as 50 minutes at 170° C., followed by 50 minutes at 165° C., followed in turn by 80 minutes at 145° C. They exhibit similar cohesive weaknesses, albeit not in the same degree as acrylic ester polymers containing tackifying resin.

The invention solves the problem of providing a self-adhesive tape, in particular for window flange masking, with a backing material that does not exhibit the disadvantages of the prior art, or not to the same extent. In particular it ought also to be possible to remove the self-adhesive tape, even after the relatively harsh baking conditions which occur in practice, without delamination, i.e., without separation of the two constituent films (PET film and sPVC film) of the laminate, so that after the self-adhesive tape has been removed it is possible to install an automotive glass window on the cathodic electrocoat adhesion base of the window flange using a reactive PU window adhesive.

This object is achieved by means of a self-adhesive tape as specified in the main claim. The subclaims relate to advantageous developments of the self-adhesive tape.

The invention accordingly provides a self-adhesive tape intended in particular for masking window flanges of automobiles, comprising a backing composed of two films disposed one above the other, the first film being composed of plasticized polyvinyl chloride (soft or sPVC) and the second of polyethylene terephthalate (PET) and the two films being joined with a laminating adhesive comprising a crosslinked, tackifier-resin-free acrylic ester polymer, characterized by a microshear travel of less than 60 μm (for a coat weight of 25 g/m²) and a delamination force of more than 3 N/cm, and also comprising a self-adhesive mass applied to the backing.

This self-adhesive mass may be applied to the first or second film.

The total thickness of the two-ply backing in one first advantageous embodiment is 90 to 300 μm, preferably 130 to 250 μm.

With further advantage the adhesive-free reverse face of the backing material may carry a release lacquer for easy unwind, specifically when the mass has good adhesion to the reverse face. The release lacquer is particularly advisable if the material is to be wound to a roll without a release medium such as release paper or release film. At the same time the lacquer ought to ensure reliable adhesion of surfacer and paint.

The coat weight of the laminating adhesive comprising the crosslinked, tackifier-resin-free acrylic ester polymer of the invention in a further advantageous embodiment of the invention is between 5 to 60 g/m², preferably 10 to 40 g/m².

The acrylic ester polymer laminating adhesive of the invention is a copolymer of different acrylic ester polymers formed from acrylic esters such as, for example n-butyl acrylate, t-butyl acrylate, n-butyl methacrylate, t-butyl methacrylate, 2-ethylhexyl acrylate, methyl acrylate, ethyl acrylate, methyl methacrylate, hydroxyethyl methacrylate, hydroxyethyl acrylate, hydroxypropyl acrylate, stearyl acrylate, isobornyl acrylate, glycidyl methacrylate, but also, if desired, of acrylic acid or of non-acrylate monomers such as vinyl acetate, or a mixture of different homopolymers or copolymers of acrylic ester monomers, said mixture being crosslinked by suitable methods. This laminating adhesive is not blended with tackifier resins.

In one preferred embodiment of the invention the acrylic ester polymer contains at least 20 mol % of the monomers n-butyl acrylate or 2-ethylhexyl acrylate.

It is prior art to crosslink self-adhesive masses based on acrylic esters in order to enhance their technical adhesive properties, particularly the shear strength. The degree of crosslinking at the same time also influences the peel strength, a measure of the adhesiveness of the self-adhesive mass to a specific substrate. Here, the following rule of thumb applies: the greater the extent to which a self-adhesive mass, with otherwise identical formula, is crosslinked, the lower its peel strength. A high peel strength, on the part both of the PET film and of the sPVC film, in addition to a high level of cohesion, is nevertheless a mandatory precondition for sufficient bonding of the two materials.

For reasons of the required cohesion it is necessary, as already stated, to dispense with tackifier resins. The very purpose of tackifier resins, however, is to increase the peel strengths of the self-adhesive mass. In order to compensate the absent resins, therefore, the self-adhesive mass would have to be uncrosslinked or crosslinked only to a very slight degree. It is therefore obvious to crosslink the resin-free self-adhesive mass only to such a low extent as to form a compromise between cohesion which is just sufficient and adhesion which is as high as possible to the PET and sPVC adherends.

Contrary to this expectation, acrylic ester polymers with a particularly high degree of crosslinking have the capacity to solve the standing problem of producing a stable bond.

One measure of the degree of crosslinking of a self-adhesive mass is the measurement of the microshear travel. The self-adhesive mass is applied to one side of a dimensionally stable backing of defined width and by its free adhesive side is adhered to a steel test adhesion substrate which has a constant temperature, above room temperature. A defined weight is suspended from a pre-prepared loop of the dimensionally stable backing below the bond, and the deflection of the test specimen is detected over a certain period of time with a measurement sensor, and recorded. The method is only defined when it is possible to rule out adhesive failure both between dimensionally stable backing and self-adhesive mass and between test adhesion substrate and self-adhesive mass, i.e., when the microshear travel reflects exclusively the viscoelastic properties of the self-adhesive mass.

For the quantitative comparison of self-adhesive mass samples it must be ensured that the coat weight of the self-adhesive mass is identical, since the microshear travel is proportional to the coat weight.

The microshear travel is zero in the case of completely inelastic materials (which does not arise in the case of self-adhesive masses) and can reach a maximum value (in this case 1000 μm) if the self-adhesive mass is crosslinked to a very low degree or not at all. The method and its implementation are elucidated in more detail in the examples, with reference to figures.

The bond strength can be described by the force required to pull the laminate apart, and will be referred to below as “delamination force”. For this purpose the laminate, with the PET side downward, is adhered to an auxiliary rail which is clamped into a tensile testing machine. Starting from one free end, parted from the PET, the sPVC film is peeled from the PET at an angle of 180° and at a defined rate. It has been found empirically, in practice, that a delamination force of 3 N/cm must at least be achieved if the aim is to prevent the laminate from separating even during unwind, during grasping of a “grip tab” for demasking, or during demasking itself. Even greater operational reliability is provided by a delamination force of more than 5 N/cm.

Thus it has been found that with a microshear travel of less than 60 μm for a laminating adhesive coat weight of 25 g/m² the necessary delamination force of more than 3 N/cm, preferably more than 5 N/cm, is achieved after the tape has been subjected to a thermal load for 50 minutes at 170° C., followed by 50 minutes at 165° C., followed by 80 minutes at 145° C.

Acrylic ester polymers are normally prepared in reactors, in which a suitable solvent is introduced as an initial charge and the monomers, which are generally in liquid form, are added in their entirety or at least partly. Polymerization takes place by addition of free-radical initiators (for example, dibenzoyl peroxide or azobisisobutyronitrile). The heat of reaction released is removed by reflux cooling of the solvent.

At the end of the polymerization a dissolved copolymer is obtained which in a first approximation comprises the comonomers in random distribution. This solution is usually further diluted with solvents to an effective coating viscosity prior to processing, in other words prior to coating onto the web-form backing.

Crosslinking takes place only after the solution has been coated out, since a crosslinked polymer is no longer fluid or is of only limited fluidity. For crosslinking, either the crosslinking agent can be added to the coating solution, or crosslinking can be achieved subsequently.

Known crosslinking methods are the addition of the abovementioned free-radical initiators directly prior to coating. These initiators randomly generate free radicals in the main chains of the polymers, which in part, under recombination, form crosslinking points. Where reactive groups such as acrylic acid functions or hydroxy functions are present, crosslinking can be carried out using polyfunctional isocyanates, such as 4,4′-di-phenylmethane diisocyanate (MDI), hexamethylene diisocyanate (HDI), toluene diisocyanate (TDI) or isophorone diisocyanate (IPDI), for example. Polyfunctional epoxide crosslinkers such as polyglycidylamine are also suitable crosslinking reagents.

Crosslinking with metal chelates is very widespread, such as aluminum acetylacetonate, for example, or with alkoxides such as titanium alkoxides (for example titanium tetrabutoxide). These crosslinkers always presuppose the presence of acrylic acid as comonomer, which forms carboxylates with the polyvalent metal ions.

Likewise possible is the crosslinking of the acrylic ester polymer using glycidyl methacrylate as comonomer: a built-in epoxide function, which particularly in the presence of a catalyst reacts with hydroxyl functions or acrylic acid to form a network.

One crosslinking method which works without crosslinking chemicals is that of treatment with electron beams, which, in a similar way to the free-radical initiators, randomly produce free radicals along the polymer main chains, these radicals recombining in part to form a network. The activity can be improved further by addition of promoters, generally polyfunctional acrylates.

The stated crosslinking mechanisms can also be combined.

The concept of the invention also embraces systems, frequently so-called prepolymers, which can be applied solventlessly as a hot melt or warm melt and which are crosslinked by UV radiation. Some of these systems can be tailored in their degree of crosslinking by way of the UV dose.

Suitable plasticized PVC films include in principle all internally or externally plasticized PVC films produced by means of calender, extruder or casting methods. In the case of external plasticization, preference is given to polymer plasticizers, since monomer plasticizers, such as phthalates, aliphatic dicarboxylic esters such as sebacates, phosphoric esters or sulfonic esters, are already volatile at the high temperatures. Examples of suitable polymer plasticizers include polyadipates, polysebacates, polyphthalates, and trimellitates. In order to achieve a further increase in the toughness of the plasticized PVC it is also possible, in addition, to carry out blending with polyethylene-vinyl acetate, nitrile rubber, butadiene-acrylonitrile-styrene copolymers or chlorinated polyolefins.

In view of the severe thermal load over the multiple temperature cycles, particular importance attaches to thermal and oxidative stabilization beyond the film production operations. There is no restriction here on materials, so that in principle it is possible to use all commercially customary stabilizers based on lead, barium, barium/zinc, calcium/zinc, tin or organic stabilizers such as aminocrotonates, particularly together with effective costabilizers, in sufficient amount.

Fillers can be added for dimensional stabilization of the plasticized PVC film in the context of the thermal stresses, but also on economic grounds. Examples of recommended fillers for this purpose include calcium carbonates such as chalk, kaolin, carbon black, silicates such as Aerosil, aluminum hydroxide, talc, dolomite, titanium dioxide or silica.

For improved processing, external lubricants, such as amide waxes, stearic acid, stearates, oleates or synthetic waxes, may be useful, and also commercially customary internal lubricants based on polymethyl methacrylate.

The coloring of the plasticized PVC film with pigmenting fillers (for example, titanium dioxide, carbon black, iron oxide, lead chromate, phthalocyanine pigments) or with organic dyes (from the group of the azo dyes or anthracene dyes) serves not only esthetic purposes but also functional purposes, by allowing the processor to distinguish the tape from the adhesion substrate, visually, in an effective way. Thus bonding defects can be easily detected visually.

Polyethylene terephthalate (PET) is a member of the group of the thermoplastic polymers and, considered formally, is a polycondensate of terephthalic acid and 1,2-ethanediol; it crystallizes rapidly in the melt to form a partially crystalline plastic. Commercially customary films of PET are initially extruded in a casting process and then biaxially oriented. A wide spectrum of different thicknesses are available commercially.

In the sense of the invention, PET films also include films of modified materials such as PETG (glycol-modified PET) or copolyesters where some of the terephthalic acid has been replaced by isophthalic acid as the aromatic dicarboxylic acid. The term “PET films” additionally embraces metalized, coextruded and/or primed versions.

To produce a two-ply structure from an sPVC film and a PET film, one of the two sides facing one another is coated with the acrylic ester polymer of the invention, with a coat weight of preferably 5 to 60 g/m², more preferably 10 to 40 g/m², and the other lamination partner is bonded without air bubbles and with application of pressure, using a laminating apparatus, for example.

Prior to the coating and/or lamination of the adherends it is possible to pretreat the film surfaces, optionally by corona discharge, flame treatment, plasma coating or wet-chemical priming for the purpose of increasing adhesion.

During the laminating operation, the assembly of sPVC and PET may be provided with a texture by means of an embossing die.

Self-adhesive masses which are in tune with the inventive concept, for the fixing of the self-adhesive tape to the window flange, are all those which withstand the exacting requirements of the temperature stresses during use of the adhesive tape without undergoing decomposition, without losing their bond strength or, following application, without leaving residues of adhesive, and which have a bond strength of more than 2 N/cm to cathodic electrocoat, in tune with the application.

Preference is given here to thermally crosslinking or radiation-crosslinked, resin-blended natural rubber self-adhesive masses, acrylic ester polymers (with and without addition of tackifier resins), silicone self-adhesive masses and polyurethane self-adhesive masses, and also synthetic rubber masses, based for instance on butyl rubber, polyisobutylene or polyethylene-vinyl acetate.

All self-adhesive compositions, where obtainable in this way, can be applied from solution, from the melt or as an aqueous dispersion to the backing using suitable coating assistants. After coating has taken place the adhesive tape can be wound up into rolls or converted to the form of sheets or diecuts.

The self-adhesive mass can be applied both to the sPVC side and to the PET side, but preferably to the PET side, since then the protective effect of the above-lying sPVC film with respect to the damage to the adhesive-tape edge during demasking is manifested more effectively.

Depending on the type of the self-adhesive mass, suitable primers are advantageous for improving the anchorage.

In order to facilitate handling it is possible for the non-adhesive reverse face of the adhesive tape to have had applied to it an unwind-force-reducing lacquer, comprising a release agent such as silicone, organofluorine compounds or polyvinyl stearylcarbamate. Alternatively the adhesive tape may be supplied on an easy-release covering material, a silicone-coated paper for example.

Rational application widths are 10 to 30 mm, depending on the size of the window to be installed. For curved bonding the width of the adhesive tape ought not to exceed 15 mm, since otherwise crease-free application is virtually impossible. It should, however, also not be less than 10 mm, so that in each case there is a sufficiently large area for the reliable adhesion of window adhesive to exposed cathodic electrocoat. For application by robot, working widths of 12 to 15 mm are usual.

Further embraced by the concept of the invention is the use of the self-adhesive tape of the invention for window masking; a window flange masked with a self-adhesive tape of the invention; and an automobile with a window flange masked with a self-adhesive tape of the invention.

The adhesive tape of the invention is described below in a preferred embodiment with reference to examples, without wishing thereby to restrict the invention in any way whatsoever. Set out additionally are comparative examples, which present unsuitable adhesive tapes.

### EXAMPLES

To illustrate the invention a total of five self-adhesive tape specimens based on the same films were prepared, two of which correspond to the concept of the invention, while three of which do not.

Films Used

The sPVC film consisted of a uniform formula based on a polyadipate-plasticized PVC in 100 μm thickness, produced on a calender. The strength of the formula at an elongation of 1% in machine direction was approximately 18 N/mm² at 23° C.

The PET film employed was a commercially customary, biaxially oriented polyethylene terephthalate film in 25 μm.

All specimens were produced in accordance with the following scheme:
the PET film was primed with a solution of polyvinylidene dichloride, applied at a rate of 0.8 g/m² on a laboratory coating unit, for the purpose of improving adhesion. Atop the primer the solution of the laminating adhesive, based on a base polymer of 50 parts of butyl acrylate, 30 parts of 2-ethylhexyl acrylate, 10 parts of vinyl acetate, 5 parts of methyl acrylate and 5 parts of acrylic acid, in accordance with table 1, was crosslinked or additized and applied by means of a coating bar so as to give, after drying, a self-adhesive mass film of 25 g/m². A reject specimen was used for determination of the microshear travel.

The PVC film was laminated with the coated PET film on a laminating station consisting of a steel roll and a rubber roll.

The laminates were primed on the polyester side in a laboratory coating machine with a solution of 2 parts of natural rubber in toluene, which had been mixed with 1 part of diphenylmethane diisocyanate, with a primer coat weight of 0.3 g/m². In a downstream operation the specimens were coated on this primer with a natural rubber self-adhesive mass, on the polyester side, so as to give an adhesive coat weight of approximately 30 g/m². The natural rubber self-adhesive mass consisted of 55 parts of natural rubber, 5 parts of zinc oxide, 6 parts of rosin glycerol ester resin, 6 parts of alkylphenol resin, 26 parts of hydrocarbon resin and 2 parts of mineral oil. The specimens were slit into strips 15 mm wide and wound up on themselves to form rolls.

TABLE 1
Crosslinking and/or additizing of the base laminating self-adhesive
mass consisting of a polymer of 50 parts butyl acrylate, 30
parts 2-ethylhexyl acrylate, 10 parts vinyl acetate, 5 parts
methyl acrylate and 5 parts acrylic acid

| | Crosslinking | Additive |
|---|---|---|
| Example 1 | 0.5% (w/w) aluminum | — |
| | acetylacetonate | |
| Example 2 | 1% HDI (hexamethylene | — |
| | diisocyanate) | |
| Counterexample 1 | — | 30% (w/w) terpene- |
| | | phenolic resin |
| Counterexample 2 | 0.3% (w/w) aluminum | — |
| | acetylacetonate | |
| Counterexample 3 | 0.5% (w/w) aluminum | 30% (w/w) terpene- |
| | acetylacetonate | phenolic resin |

### Test Criteria

Decisive test criteria for the present problem situation were regarded as being essentially the following, which were therefore employed:
microshear travel
delamination force

### Test Implementation

Microshear Travel

The test criterion of the microshear travel is elucidated in detail on the basis of the figures described below.

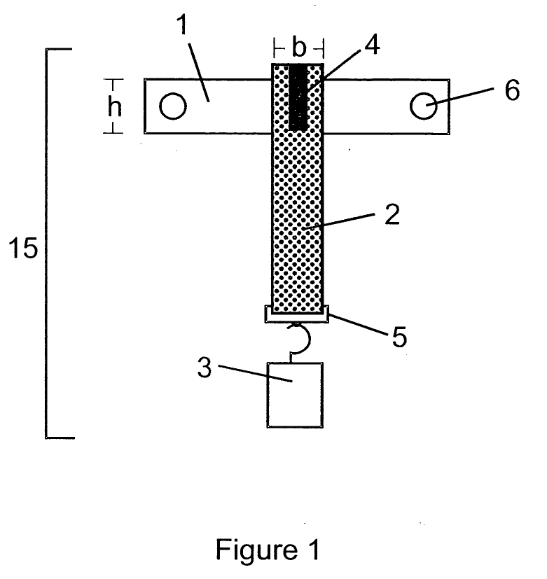

FIG. 1 shows the preparation of the specimen to be measured,

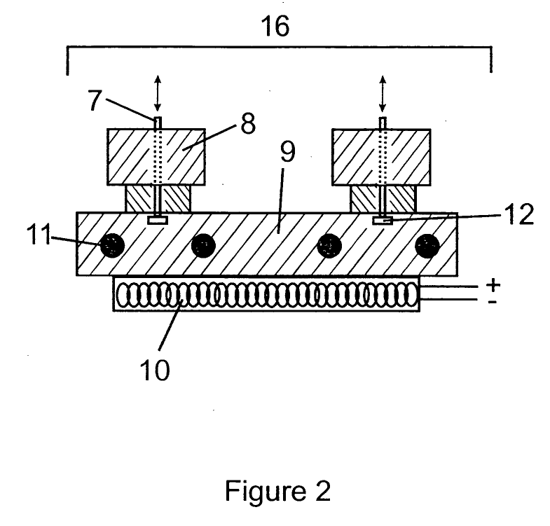

FIG. 2 shows the measurement apparatus required,

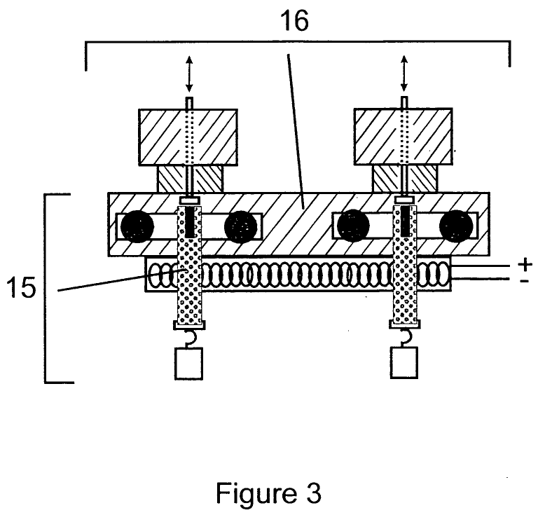

FIG. 3 shows the implementation of the measurement, in front elevation, and

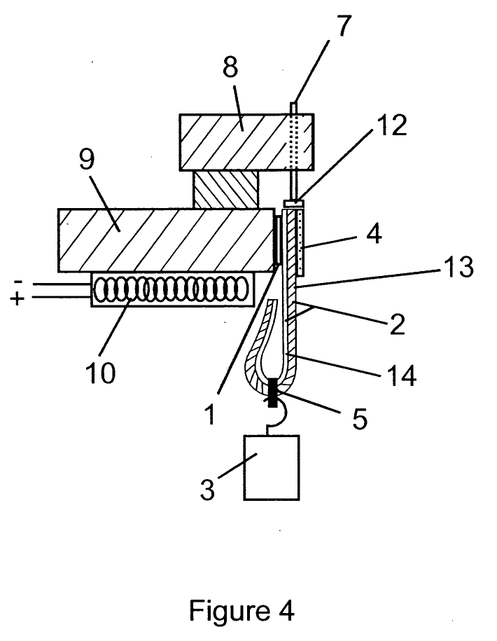

FIG. 4 shows the implementation of the measurement, in side elevation.

FIG. 1 depicts the preparation of the specimen to be measured. A specimen strip (2) of width b=10 mm of the PET film coated with the acrylic ester polymer with a uniform coat weight of 25 g/m² is adhered with the adhesive transversely to a test plate (1) of steel, with a width h=13 mm, in such a way that the specimen strip overhangs a few millimeters at the top and several centimeters at the bottom. The plate has drillholes (6) which can be used to attach the ready-prepared test specimen (15) to the measurement apparatus. The bond was rolled over three times with a steel roller weighing 2 kg and at a speed of about 10 meters per minute, in order to produce a defined applied pressure. On the reverse face of the test strip a self-adhesive reinforcing strip (4) of polyester film 100 μm thick was adhered and cutoff flush with the overhang of a few millimeters. The reinforcing strip serves as a solid mounting point for the measuring sensor of the measurement apparatus. The overhang of several centimeters is formed into a loop, into which a clamp (5) is inserted, which subsequently accommodates the weight (3).

FIG. 2 shows the measurement apparatus. The measurement apparatus (16) consists of an electrical heating element (10) which heats the metallic sample carrier (9) to the desired temperature above the ambient temperature. Located above the sample carrier (9) with the screws (11) for fastening the two test specimens which are always measured in parallel, are the measuring heads (8) with the micrometer measuring sensors (7) and their contact area (12). The micrometer measuring sensors (7) have a negligible inherent weight and can be moved in the vertical direction with virtually no friction. The vertical deflection of 1000 μm maximum is registered by connected electronics, with a resolution of 1 μm, and recorded and depicted numerically or graphically by means of appropriate software. The measuring sensors (7) follow a downward movement of the test specimens under the influence of the suspended weight, and so detect the microshear travel.

FIGS. 3 and 4 show the implementation of the measurement in a front elevation and a side elevation, respectively. The test specimen (15) is fixed into the measuring apparatus (16), which has been heated beforehand to 40° C., in the way depicted in the figures. The contact area (12) of the measuring sensors (7) is mounted on the top edge of the test specimen, which consists of the test plate (1), the self-adhesive mass (14), the dimensionally stable backing (13) and the reinforcing strip (4), and the measurement signal is set at zero.

When the test plate (1) after a few minutes has taken on the temperature of the sample carrier (9), which is heated by the heating element (10), the weight (3) is suspended with the weight force of 50 g in the bracket (5). This is the moment at which measurement begins.

After 15 minutes the measurement is stopped and the average value is formed from the two individual measurements of the microshear travel and expressed in the dimension “μm”.

The result is only valid when no adhesive failure occurs.

Delamination Force

Strips of the specimen rolls are adhered to steel panels which are baked in a forced-air oven first at 170° C. for 50 minutes and then cooled at room temperature for 10 minutes.

Subsequently this procedure is repeated at 165° C. for 50 minutes and again at 145° C. for 80 minutes. Starting from one end, the sPVC film is separated from the PET using a knife, on each of the strips, and peeled back a few centimeters.

To measure the delamination force, the steel panels, after cooling to room temperature (23° C.), are clamped into a tensile testing machine and the measuring head is connected to the pre-prepared free end of the sPVC film.

Subsequently the sPVC is peeled from the PET at an angle of 180° and a speed of 0.3 m/min, and the average value of the delamination force is read off in the dimension “N/cm”.

As additional information it is possible to use the type of fracture. Where the adhesive remains quantitatively on one of the two films, the fracture is adhesive; if the adhesive splits, the fracture is cohesive. Occasionally a hybrid form as well is observed, referred to as hybrid fracture.

### Results

The results are summarized in table 2.

TABLE 2
Overview of the test results of the individual example specimens

| | Microshear | Delamination | |
|---|---|---|---|
| | travel in μm | force in N/cm | Type of fracture |
| Example 1 | 25 | 8.8 | adhesive |
| Example 2 | 53 | 6.3 | adhesive |
| Counterexample 1 | >1000* | 0.8 | cohesive |
| Counterexample 2 | 176 | 2.4 | adhesive |
| Counterexample 3 | 386 | 1.3 | cohesive |

*Specimen fell down, cohesive fracture after about 5 minutes

It is apparent that the delamination force values of the thermal load that are necessary for functional application are achieved only by specimens which exhibit a low microshear travel.

1. A self-adhesive tape for masking window flanges of automobiles, comprising a backing which is formed of two films disposed one above the other, the first film being composed of soft plasticized polyvinyl chloride (sPVC) and the second of polyethylene terephthalate (PET) and the two films being joined to each other with a laminating adhesive comprised of a crosslinked, tackifier-resin-free acrylic ester polymer having a microshear travel of less than 60 μm (for a coat weight of 25 g/m²) and a delamination force of more than 3 N/cm, and a self-adhesive mass applied to the backing.

2. The self-adhesive tape as claimed in claim 1, wherein the self-adhesive mass is applied to the PET film side of the backing.

3. The self-adhesive tape as claimed in claim 1, wherein the adhesive-free reverse face of the backing material carries a release lacquer which, in addition to its release properties also provides for effective surfacer and paint adhesion.

4. The self-adhesive tape as claimed in claim 1, wherein the total thickness of the two-ply backing is 90 to 300 μm.

5. The self-adhesive tape as claimed in claim 1, wherein the tackifier-resin-free, acrylic ester polymer laminating adhesive is a copolymer of different acrylic ester polymers formed from acrylic esters selected from the group consisting of n-butyl acrylate, t-butyl acrylate, n-butyl methacrylate, t-butyl methacrylate, 2-ethylhexyl acrylate, methyl acrylate, ethyl acrylate, methyl methacrylate, hydroxyethyl methacrylate, hydroxyethyl acrylate, hydroxypropyl acrylate, stearyl acrylate, isobornyl acrylate and glycidyl methacrylate, or formed from one or more of said acrylic esters and acrylic acid or of one or more of said acrylic esters and non-acrylate monomers, or is a mixture of different homopolymers or copolymers of acrylic ester monomers.

6. The self-adhesive tape as claimed in claim 1, wherein the acrylic ester polymer contains at least 20 mol % of the monomers n-butyl acrylate or 2-ethylhexyl acrylate.

7. The self-adhesive tape as claimed in claim 1, wherein the laminating adhesive is applied at 5 to 60 g/m².

8. The self-adhesive tape as claimed in claim 1, wherein the crosslinked, tackifier-resin-free acrylic ester polymer has a microshear travel of less than 60 μm (for a coat weight of 25 g/m²) and a delamination force of more than 5 N/cm.

9. A method of masking window flanges, which comprises masking said window flanges with the self-adhesive tape of claim 1.

10. A window flange masked with a self-adhesive tape as claimed in claim 1.

11. An automobile with a window flange masked with a self-adhesive tape as claimed in claim 1.

12. The self-adhesive tape of claim 4, wherein said thickness is 130 to 250 μm.

13. The self-adhesive tape of claim 5, wherein said copolymer is a copolymer of one or more of said acrylic ester and non-acrylate monomers wherein said non-acrylate monomers is vinyl acetate.

14. The self-adhesive tape of claim 7, wherein the laminating adhesive is applied at 10 to 40 g/m².
